(19) United States
(12) Patent Application Publication
(10) Pub. No.: US 2012/0312844 A1
(43) Pub. Date: Dec. 13, 2012

(54) AUTOMATIC DISPENSING MODULAR ASSEMBLY FOR GRANULES AND METHOD OPERATING THEREOF

(75) Inventors: Ashim Chatterjee, West Bengal (IN); Mani George Kandappali, Pondicherry (IN); Balasubramaniam Munusamy, Chennai (IN)

(73) Assignee: Tata Tea Limited, Kolkata (IN)

(21) Appl. No.: 13/263,624

(22) PCT Filed: Aug. 13, 2009
(86) PCT No.: PCT/IN09/00454

§ 371 Date: Oct. 7, 2011

(30) Foreign Application Priority Data
Apr. 8, 2009 (IN) 600/KOL/2009

(51) Int. Cl. A01C 15/04

(52) U.S. Cl. 222/636

(57) ABSTRACT

The automatic dispensing modular assembly includes plurality of granule dispensing modules to dispense a pre-set quantity of a selectable granular material out of different types of granular materials provided in different dispensing modules. Each granule dispensing module includes a canister sub-assembly (30) and a assembly (40) drive means. The canister sub-assembly (30) includes a granule canister (5) and a granule volumetric dozer (16) to dispense consistently and accurately a pre-set quantity of a granular material. The drive means according to one embodiment is a pneumatic cylinder sub-assembly (40) which includes a pneumatic cylinder (4) having piston rod (17) capable of imparting forward and backward motion to the granule conveyor (6) coupled to the piston rod (17) through granule conveyor coupler (15). The granular material is dispensed through granule dispensing tube (20) when the granule volumetric dozer (16) is brought in vertical alignment with the granule dispensing port (7).

### TECHNICAL FIELD

This invention relates to an automatic dispensing modular assembly for granules and method of operating thereof wherein the modular assembly includes at least one granule dispensing module to dispense a granular material such as a flavoring agent.

### BACKGROUND OF THE INVENTION

Dispensing machines are known in the art for dispensing powders used to prepare beverages which are constituted by mixing a pre-set quantity of water soluble food powder like milk powder, soup powder, etc. into a pre-set quantity of hot or cold water dispensed into a dispensing cup through dispensing lines. These powders do not easily flow-out of a canister in which they are contained, in a consistent manner due to their cohesive nature. Further a canister containing milk powder is difficult to be completely emptied as some amount of milk powder always remains in the canister that cannot be dispensed. To overcome these problems, many of the assemblies known in the art, use hopper containers incorporating complex mechanisms of plurality of agitating wheels and a revolving delivery and dosing member like an auger driven by a motor connected to the shaft of the revolving member. Such containers are not suitable for dispensing a flavoring agent especially in granular form since the dispensed quantity cannot be precisely controlled due to granular materials being less cohesive in nature.

U.S. Pat. No. 4,610,378 reports a closed container for food powders in automatic beverage distribution machines wherein the container has a delivering duct in the lower part of the container, a delivering mouth formed by an opening at the end of container, a revolving delivering and dosing member rotatably supported inside the duct and extending through said mouth, a motor to which said revolving delivering and dosing member is removably connected and a plate closing member supported against said mouth and is movable from the closing position to an opening position by the delivering and dosing member during its rotational movement.

A drawback of the above delivering and dosing mechanism reported in the above cited patent is that it is not suitable for dispensing pre-set and accurate quantity of granular material as it does not incorporate any means for consistent dispensing of a pre-set quantity of a powder.

Another drawback of the container for food powders reported in the above patent is that it incorporates a complex mechanism of a revolving member connected to a shaft which is mechanically operated by a motor. Such a complex container for food powder may be cumbersome for a configuration for plurality of granular materials where a selectable granular material like flavoring agent is to be dispensed.

Still another drawback of the container for food powders reported in above identified patent is that the container is not airtight and susceptible to ingress of humidity which may cause granule to agglutinate.

U.S. Pat. No. 6,834,779 reports a dispensing canister comprising a reservoir containing beverage-forming or food-forming powder and provided with a main agitating wheel and a secondary agitating wheel engaged with the main agitating wheel which promote downward motion of the powder. At the bottom of the reservoir, a rotatable volumetric dosing auger, longitudinally extending between the front and rear walls of the reservoir, is provided which is arranged such that the plurality of teeth circumferentially provided on the main agitating wheel cause transport of the powder which varies as a function of the longitudinal position along the dosing means.

A drawback of the dispensing canister reported in the above patent is that it transports and delivers food powder or beverage forming-powders by the rotational movement of the auger and wherein the volume of powder dispensed is adjusted by modification of auger by which the volume of powder delivered at the outlet is reduced or increased. Such an arrangement is not suitable for dispensing very small and consistent quantities of granular materials

U.S. Pat. No. 7,044,366 reports of a multi-flavored hot beverage dispenser which incorporates plurality of flavor dispensing units. Each flavor dispensing unit includes a flavor container in communication with a pump system via a flexible tube. When activated by main control board via a control line, the activated pump system pumps liquid flavor syrup from the linked flavor container into the flavor discharge line from where it is transported and dispensed into the hot drink emanating from the discharge line at the dispensing nozzle of the beverage dispenser. The flavor discharge line is attached to dispensing nozzle through a flavor dispensing nozzle which has plurality of flavor supply ports extending from and in communication with the main discharge passage formed by the main body of the flavor dispensing nozzle. The number of supply ports corresponds to the number of flavors desired to be dispensed by the dispenser. Each flavor requires a separate discharge line for transporting and dispensing the flavor pumped by the pump system from the flavor container, a separate pump for each flavor syrup container, a separate supply line connecting the flavor container to the pump and a separate flavor container containing the flavor syrup for each flavor.

A limitation of the flavor dispensing unit embodied in the above beverage dispenser is that it requires the flavor to be in the form of liquid which could be pumped up by the pump system to the dispensing nozzle of the beverage dispenser through flavor discharge line and therefore is not suitable for dispensing granular materials.

Another drawback of the above flavor dispensing unit is that the cross-flavoring takes place below the mixer and at the dispensing port of the beverage.

### SUMMARY OF THE INVENTION

In accordance with the present invention there is provided an automatic dispensing modular assembly for granules and method of operating thereof wherein the modular assembly includes at least one granule dispensing module to dispense a granular material such as a flavoring agent. A granule dispensing module includes a granule canister containing one type of granular material and a granule volumetric dozer to dispense consistently and accurately a pre-set quantity of that granular material. In the modular assembly of the present invention, plurality of granule dispensing modules, with the help of compressed air, can be used to dispense a pre-set quantity of a selectable granular material out of a plurality of granular materials provided in different granule dispensing modules. The automatic dispensing modular assembly of the present invention, can be integrated with a beverage dispensing assembly such as the one disclosed in co-pending Indian patent application No. 780/KOL/2008 (PCT/IN2008/00871) which is deemed to be incorporated herein in its entirety, to dispense accurately, a pre-set quantity of a granular material selectable from plurality of granular materials provided in different modules, automatically and directly into a fresh beverage dispensed into a dispensing cup by the beverage dispensing assembly. Different granular materials are dispensed by different granule dispensing modules thereby preventing cross-contamination or mixing of the granular materials.

An object of the present invention is therefore to provide an automatic dispensing modular assembly for granules and method of operating thereof wherein said automatic dispensing modular assembly for granules includes at least one granule dispensing module to dispense a pre-set quantity of any granular material like a flavoring agent in granular form.

Another object of the present invention is to provide an automatic dispensing modular assembly for granules which in combination with a beverage dispensing assembly such as the one disclosed in co-pending patent application no. 780/KOL/2008, can be used to automatically dispense a pre-set and accurate quantity of a selectable granular material such as a flavoring agent into the fresh beverage in a dispensing cup, dispensed by the beverage dispensing assembly.

Still another object of the present invention is to provide an automatic dispensing modular assembly for granules, wherein one unit of granule dispensing module is sleek in size so that the modular assembly with plurality of such granule dispensing modules, can be integrated with a beverage dispensing assembly such as the one disclosed in the co-pending patent application no. 780/KOL/2008, without making the assembly unwieldy.

Yet another object of the present invention is to provide an automatic dispensing modular assembly for granules wherein each unit of granule dispensing module is such that the modular assembly having plurality of such granule dispensing modules can be integrated with a beverage dispensing assembly such as the one disclosed in the co-pending patent application no. 780/KOL/2008, which will enable direct and automatic dispensing of any granular powder such as a flavoring agent into the dispensing cup containing fresh beverage dispensed by the beverage assembly wherein the flavoring agent would be selectable out of the plurality of flavoring agents available in the granule canisters of different granule dispensing modules of the modular assembly, as per the choice expressed by an operator, indicated by depressing an appropriate switch on the front control panel of such a beverage dispensing assembly.

Further object of the present invention is to provide an automatic dispensing modular assembly for granules wherein the granule canister is easily removable and replaceable which enables replacement of the granule canister containing one flavor with the granule canister containing another desired flavor. Thus, in addition to choice of flavors that may be available by using plurality of granule dispensing modules with one flavor available in one module, the choice of flavors can be further varied by substituting the granule canister in any granule dispensing module with a granule canister containing the desired flavor and by providing a new granule volumetric dozer within the replaced granule canister calibrated according to the required dosing of the new flavoring agent. The ease of detachment of the granule canister also enables easy cleaning and maintenance of the granule canister as well as of the granule dispensing module.

Still further object of the present invention is to provide an automatic dispensing modular assembly for granules embodying plurality of granule dispensing modules, wherein each granule dispensing module dispenses only one type of granular material thereby preventing cross-flavoring and cross-contamination of the different granular materials, contained in the plurality of granule dispensing modules.

Yet further object of the present invention is to provide an automatic dispensing modular assembly for granules which is fully automatic thereby eliminating the need for external flavor delivery means such as use of flavored tea bags or manual addition of a flavor to a beverage.

Still further object of the present invention is to provide an automatic dispensing modular assembly for granules which uses a granule volumetric dozer to automatically dispense a pre-set and accurate quantity of the granular material into the beverage in a dispensing cup thereby ensuring a high degree of accuracy in the amount of granules dispensed and thus ensuring consistency in the flavoring of the end-cups of beverages served to the consumers.

Yet further object of the present invention is to provide an automatic dispensing modular assembly for granules which uses minimal moving components due to which it requires low maintenance and has enhanced reliability besides reducing the cost.

Still further object of the present invention is to provide an automatic dispensing modular assembly for granules which enables dispensing of a wide range of flavoring materials in a granular form into a beverage with only a marginal add-on-cost per cup as compared to using means such as flavored tea bags.

Yet further object of the present invention is to provide an automatic dispensing modular assembly for granules wherein the granule canister has the capacity to contain quantity of granules which is sufficient for dispensing granules in large number of cups of beverage thereby obviating the need for frequent refilling of canister and thus making the modular assembly user-friendly.

Still further object of the present invention is to provide an automatic dispensing modular assembly for granules which uses flavoring agent, etc. in granular form which results in zero aroma contamination with other flavors and requires no clean-up/maintenance of the pipes or the associated mechanism.

Even further object of the present invention is to provide an automatic dispensing modular assembly for granules wherein the tapping effect and the vibrations due to the forward and backward movement of the granule conveyor in the granule conveyor channel provided near the base of the granule canister helps in the complete filling of the granule volumetric dozer thereby enabling dispensing of an accurate quantity of the granular material.

Still further object of the present invention is to provide an automatic dispensing modular assembly for granules which when used in combination with a beverage dispensing assembly known in the art such as the one disclosed in the co-pending patent application no. 780/KOL/2008 enables dispensing of a wide range of flavored beverages from the same assembly.

Yet further object of the present invention is to provide an automatic dispensing modular assembly for granules which when used in combination with a beverage dispensing assembly such as the one disclosed in co-pending patent application no. 780/KOL/2008, takes same time to dispense the flavored beverage as compared to dispensing the same beverage without a flavor since the preparation of the beverage and the dispensing of the flavor happens concurrently.

Still further object of the present invention is to provide an automatic dispensing modular assembly for granules where the granule canister is airtight at the opening used for filling granules as well as at the granule dispensing port thus preserving the freshness and quality of the granular material and thereby enhancing the shelf life of the granular material loaded in the granule canister.

Other objects and advantages of the present invention will be evident from the ensuing detailed description and illustration of the invention with accompanying drawings.

### BRIEF DESCRIPTION OF THE DRAWINGS

The invention will now be illustrated with accompanying figures, which are intended to illustrate one of the embodiment in which the present invention may be practiced. The accompanying figures are not intended to be taken restrictively to imply any limitation on the scope of the present invention. It is to be noted that the invention is not deemed limited to the exact construction shown by these Figures. Any modifications, adaptations, equivalent changes by the persons skilled in the art employing the principles and functional features of components and sub-assemblies as embodied in the present invention are intended to be within the scope of the present invention. In the accompanying figures:

FIG. 1:—shows the sectional view of the overall assembly of one granule dispensing module of the modular assembly of the present invention, with canister sub-assembly in normal position.

FIG. 2:—shows the sectional view of the canister sub-assembly of one granule dispensing module, in the dispensing position, when the upper end of granule volumetric dozer is in vertical alignment with compressed air port and the lower end thereof is in vertical alignment with the granule dispensing port.

FIG. 3:—shows the sectional view of the pneumatic cylinder sub-assembly of one granule dispensing module of the modular assembly of the present invention.

### DESCRIPTION OF INVENTION W.R.T. DRAWINGS

According to this invention, there is provided an automatic dispensing modular assembly for granules which includes at least one granule dispensing module which can consistently dispense a pre-set and accurate quantity of any material in granular form. The modular assembly of the present invention with plurality of granule dispensing modules, can be integrated with a beverage dispensing assembly such as the one disclosed in the co-pending patent application no. 780/KOL/2008 (PCT/IN2008/00871) which is deemed to be incorporated herein in its entirety and such an integrated assembly can be used to dispense a fresh beverage containing desired flavors in granular form, selectable out of the plurality of flavors provided in the different granule canisters of the different granule dispensing modules of the modular assembly. Further, the granule canisters of the different granule dispensing modules of the modular assembly being easily replaceable, the choice of flavors can be further varied by substituting the granule canister containing one flavor in granular form with a granule canister containing another flavor in the granular form and by providing a new granule volumetric dozer calibrated according to the required dosing of the new flavoring material in granular form.

Each granule dispensing module of the modular assembly of the present invention is dimensionally sleek, with minimal moving components and the modular assembly of the present invention can be integrated with a beverage dispensing assembly, without making the integrated assembly unwieldy or occupying any significant additional table space. Since the cost of the single granule dispensing module is low, the add-on cost per cup of flavoring the beverage, with a flavor of choice, is very minimal, when compared to other means for flavoring the beverage such as flavored tea bags.

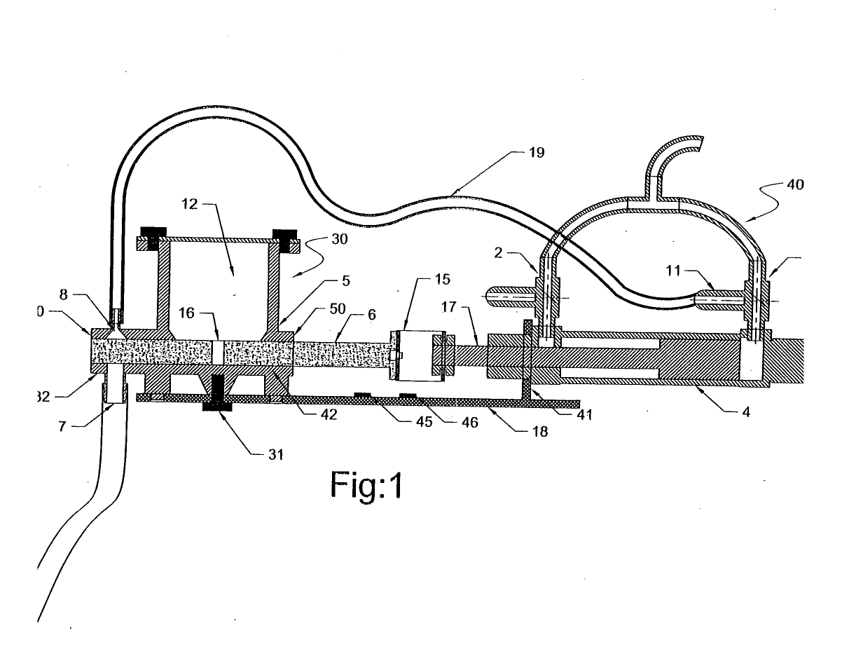

Referring to FIG. 1, each granule dispensing module of the automatic dispensing modular assembly for granules of the present invention includes a canister sub-assembly (30) and a pneumatic cylinder sub-assembly (40) which are coupled together through a granule conveyor coupler (15). The canister sub-assembly (30) is mounted on a base plate (18). The pneumatic cylinder sub-assembly (40) is mounted on a vertically upward extending plate (41) which is integrally welded to the base plate (18). The pneumatic cylinder sub-assembly (40) is mounted in such a way that the piston rod (17) of the pneumatic cylinder (4) is in horizontal alignment with the granule conveyor (6) so that when piston rod (17) moves forward, it imparts forward motion to the granule conveyor (6) via the granule conveyor coupler (15). A compressed air port (8) is provided on the upper surface of the horizontally extending portion (32) of the granule canister (5) whereas a granule dispensing port (7) is provided on the lower surface of the horizontally extending portion (32) of the granule canister (5) in such a way that the granule dispensing port (7) is aligned exactly vertically below the compressed air port (8). The exhaust port (11) of the air solenoid valve (1) is in communication with said compressed air port (8) via an exhaust air conveyor tube (19). Two activation switches (45, 46) are provided on the base plate (18) wherein activation switch (45) is for activating air solenoid valve (1) and activation switch (46) is for activating air solenoid valve (2).

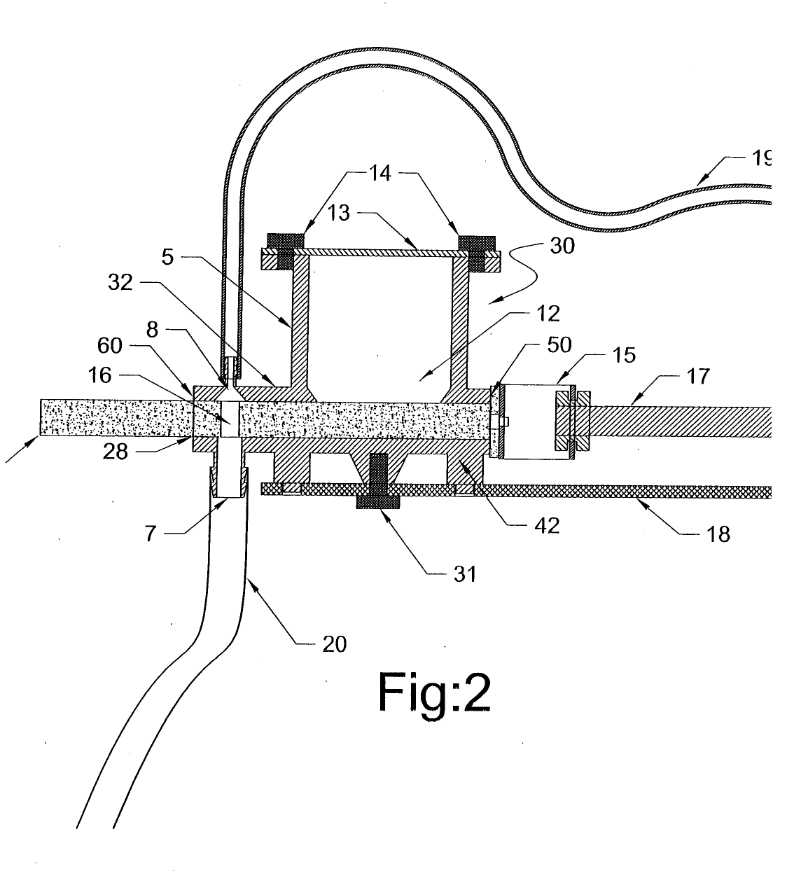

Referring to FIG. 2, the canister sub-assembly (30) of one granule dispensing module of the modular assembly of the present invention includes a granule canister (5) mounted on a base plate (18). The granule canister (5) has, near granule canister base (42), a horizontally extending portion (32) having proximal end (50) and distal end (60).There is no limitation on the capacity of granule canister (5). The granule dispensing module of the present invention would be workable with a granule canister of higher capacity. When used for dispensing flavoring agent in granular form, which is required to be dispensed in very small quantities, the granule canister (5) with even a capacity of 50 grams, may be sufficient for dispensing flavoring agent into around 200-300 dispensing cups of beverage. Thus the capacity of the granule canister (5) may be made such that it obviates the need for frequent refilling of the granule canister (5) with the granular material thereby making the granule dispensing module user-friendly. The granule canister (5) has a granule conveyor channel (28) at the granule canister base (42), said granule conveyor channel (28) being dimensionally and horizontally aligned with granule conveyor (6) so that the granule conveyor (6) can move to and fro freely through this granule conveyor channel (28). The granule conveyor channel (28) extends through the entire length of the horizontally extending portion (32) of granule canister (5) from proximal end (50) to the distal end (60). At around one-third of its length from its proximal end (50), the granule conveyor (6) has a granule volumetric dozer (16) which is a through vertical cylindrical hole. In the normal position as shown in FIG. 1, said granule volumetric dozer (16) is positioned in the middle of the base of the granule canister (5). The granule canister (5) has a canister cavity (12) which is open at the upper end. The granule conveyor (6) is horizontally positioned through the granule conveyor channel (28) provided at the base of the canister cavity (12) and extends from the distal end (60) to the granule conveyor coupler (15). The upper end of the canister cavity (12) of the granule canister (5) is closed airtight by means of canister lid (13) which is fixed by fixing means (14, 14) to the top end of the granule canister (5). The lower side of the horizontally extending portion (32) of the granule canister (5) is provided with a granule dispensing port (7) to which a granule dispensing tube (20) is connected through which the granular material from the granule volumetric dozer (16) is dispensed. A compressed air port (8) is provided on the upper side of the horizontally extending portion (32) of the granule canister (5) and is connected by exhaust air conveyor tube (19) to the exhaust port (11) (FIG. 1) of the air solenoid valve (1) (FIG. 1). The granule canister (5) is fixed to the base plate (18) by a single fixing means (31) like a screw and is therefore easily detachable.

In the normal position as shown in FIG. 1, granule volumetric dozer (16) is positioned within the canister cavity (12) so that when granular material is present in the canister cavity (12), the granule volumetric dozer (16) having pre-determined volume in accordance with the required dosing of the granular material, gets automatically filled with the granular material from canister cavity (12) due to gravitational flow of granular material and due to the vibrations created by the tapping effect of forward and backward movement of the granule conveyor (6). In the dispensing position shown by FIG. 2, the granule conveyor (6) is moved forward by the forward motion of the piston rod (17) upon actuation by pneumatic cylinder (4) (FIG. 1) due to piston rod (17) and the granule conveyor (6) being coupled by the granule conveyor coupler (15). This forward motion of the granule conveyor (6) is completed when further forward motion of granule conveyor coupler (15) is stopped by the proximal end (50) of the horizontally extending portion (32) of granule canister (5). At this position, the granule volumetric dozer (16) is vertically aligned with the compressed air port (8) on the upper side and with the granule dispensing port (7) on the lower side. At this aligned position, the gust of air received through the exhaust air conveyor tube (19) from the exhaust port (11) (FIG. 1) of air solenoid valve (1) (FIG. 1) blows down the granular material contained in the granule volumetric dozer (16) through the granule dispensing tube (20) into the dispensing container (not shown).

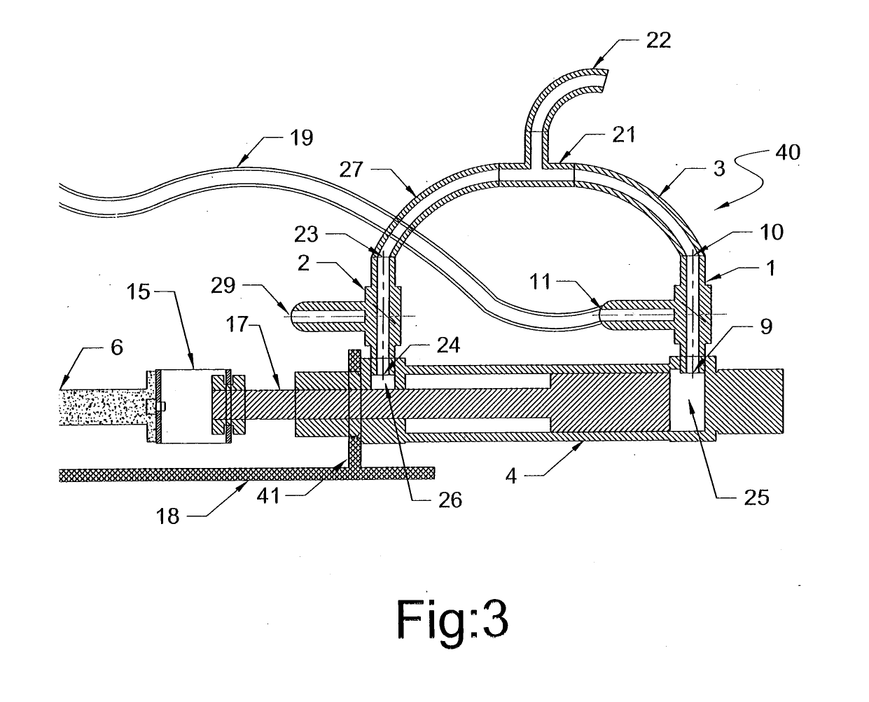

Referring to FIG. 3, the pneumatic cylinder sub-assembly (40) includes a pneumatic cylinder (4) mounted on a vertically upward extending plate (41) integrally welded to the base plate (18). The piston rod (17) of the pneumatic cylinder (4) extends into the interior of the granule conveyor coupler (15) through a dimensionally aligned aperture provided on one of its sides that faces the pneumatic cylinder (4). The mounting of the pneumatic cylinder (4) is such that the piston rod (17) is in horizontal alignment with the granule conveyor (6). This granule conveyor (6) is attached to the granule conveyor coupler (15) from the side opposite to the side from which the piston rod (17) extends therein. With the help of granule conveyor coupler (15), to and fro motion of the piston rod (17) is imparted to the granule conveyor (6).

At rear end of the pneumatic cylinder (4) is provided an air solenoid valve (1) having an inlet port (10) and an exhaust port (11). The inlet port (10) is connected to a compressed air storage tank (not shown) by an inlet tube (3) and air compressor connecting tube (22) through a three-way connector (21). The normally closed port (9) of the air solenoid valve (1) is connected to the pneumatic cylinder rear end port (25). At the front end of the pneumatic cylinder (4) is provided an air solenoid valve (2) whose inlet port (23) is connected to the compressed air storage tank (not shown) by an inlet tube (27) and air compressor connecting tube (22) via a three-way connector (21). The normally closed port (24) of the air solenoid valve (2) is connected to the pneumatic cylinder front end port (26). The air solenoid valve (2) is also provided with an exhaust port (29). The exhaust port (11) of air solenoid valve (1) is connected to the compressed air port (8) (FIG. 1) provided on the upper surface of the horizontally extending portion (32) (FIG. 1) of the granule canister (5) (FIG. 1) by exhaust air conveyor tube (19).

### Method of Operating the Modular Assembly of the Present Invention

The method of operating the modular assembly is described with respect to one granule dispensing module. Identical method is to be adopted for all the modular units of the assembly. Granular material to be dispensed is loaded into the granule canister (5) through the canister cavity (12). After filling the granule canister (5) with the granular material, the canister top is closed by means of the canister lid (13) which is secured using fixing means (14, 14). The granule volumetric dozer (16) provided in the granule conveyor (6), being beneath the canister cavity (12), gets automatically filled with the granular material, due to downward flow under gravity and tapping effect and vibrations due to forward and backward motion of the granule conveyor (6).

When the air solenoid valve (1) is activated, the normally closed port (9) opens and allows inflow of compressed air from the compressed air storage tank (not shown) through the air compressor connecting tube (22) and inlet tube (3) via three-way connector (21) and inlet port (10). The compressed air enters the rear end of the pneumatic cylinder (4) through the pneumatic cylinder rear end port (25) and causes the piston rod (17) of the pneumatic cylinder (4) to move forward. The piston rod (17) being coupled to the granule conveyor (6) via granule conveyor coupler (15), the forward movement of the piston rod (17) in turn causes the granule conveyor (6) to move forward. At the stage when the forward motion of the granule conveyor (6) is complete, the granule volumetric dozer (16) comes in vertical alignment with the compressed air port (8) and the granule dispensing port (7). At this instant, the air solenoid valve (1) is deactivated which makes the exhaust port (11) to open thereby releasing the compressed air inside the pneumatic cylinder (4) through exhaust air conveyor tube (19) into the compressed air port (8). At this stage, the compressed air port (8) and granule volumetric dozer (16) being in vertical alignment with the granule dispensing port (7), the sudden gust of air through the compressed air port (8) passes through the granule volumetric dozer (16) and granule dispensing port (7) thereby conveying the granular material contained inside the granule volumetric dozer (16) into the granule dispensing tube (20) through granule dispensing port (7).

At this stage when granular material has been dispensed through the granule dispensing tube (20), air solenoid valve (2) is activated which opens the normally closed port (24) and allows the compressed air from the compressed air storage tank (not shown) through air compressor connecting tube (22) and inlet tube (27) via three-way connector (21) and inlet port (23) to enter the front end of the pneumatic cylinder through pneumatic cylinder front end port (26). This inflow of compressed air into the front end of the pneumatic cylinder (4) causes the piston rod (17) of the pneumatic cylinder (4) to move backward. The piston rod (17) which is coupled to the granule conveyor (6) via granule conveyor coupler (15) also moves backward to its normal position. At this stage, the granule volumetric dozer (16) in the granule conveyor (6) is within the canister cavity (12) resulting in refilling of the granules from the canister cavity (12) into the granule volumetric dozer (16) due to gravity and the vibration created by the tapping effect of the backward movement of the granule conveyor (6). Air solenoid valve (2) is then deactivated which releases the compressed air contained within the pneumatic cylinder (4) through the exhaust port (29) into the atmosphere. The granule dispensing module is then ready for the next operating cycle.

For a modular assembly involving plurality of the granule dispensing modules offering a choice of the granular material to be dispensed, with one different granular material on one granule dispensing module, the granular material is first selected by the operator by operating an appropriate switch on the front control panel (not shown) of the assembly (not shown). Based on the granular material selected, an electronic processor (not shown) activates the air solenoid valve (1) of the granule dispensing module having the desired granular material. After dispensing of the granular material as explained above, the electronic processor (not shown) activates the air solenoid valve (2) of the same granule dispensing unit bringing back the granule conveyor (6) of that unit back to its normal position, as explained above. The assembly is then ready for selection of the next desired granular material.

According to another embodiment of the present invention, the pneumatic cylinder (4) can be replaced with an electrically operated drive such as a screw rod or a rack and pinion, or the granule conveyor (6) can be operated manually.

It is to be understood that the principles, functional features of different components/sub-assemblies of the granule dispensing module as taught by the present invention can be employed by those skilled in the art in variant embodiments by making adaptations, modifications and equivalent changes. Such variant embodiments are intended to be within the scope of the present invention, which is further set forth under the claims which follow.

1. An automatic dispensing modular assembly for granules comprising at least one granule dispensing module and each said granule dispensing module comprises:
(a) a canister sub-assembly (30) comprising a granule canister (5) having a canister cavity (12) provided with an airtight canister lid (13), said granule canister having near its granule canister base (42),
at least one horizontally extending portion (32) which has
a granule conveyor channel (28) through which a dimensionally aligned-granule conveyor (6) is capable of to and fro free motion, said horizontally extending portion having a proximal end (50) and distal end (60) and wherein said granule conveyor (6) in the normal position is extending from granule conveyor coupler (15) to said distal end (60) and wherein further said granule conveyor is provided with
a granule volumetric dozer (16) of predetermined volume and comprising a through vertical cylindrical hole which in normal position, is within said canister cavity and whereas in the dispensing position the lower end of said granule volumetric dozer is in vertical alignment with granule dispensing port (7); and
(b) a drive means to impart forward and backward motion to the said granule conveyor through granule conveyor coupler (15).

2. An assembly as claimed in claim 1 wherein alternate drive means for imparting forward and backward motion to said granule conveyor is selected from an electrically operated rod and a rack and pinion.

3. An assembly as claimed in claim 1 wherein said canister lid is fixed by fixing means like (14,14).

4. A method of operating a granule dispensing module comprising the steps of:
(a) loading the granular material into the canister cavity (12) of the granule canister (5) and closing it by canister lid (13) with fixing means (14,14);
(b) activating the air solenoid valve (1) by depressing activation switch (45) thereby moving the piston rod (17) forward which in turn moves forward the granule conveyor (6) to a position where the granule volumetric dozer (16) is in vertical alignment with the granule dispensing port (7) and compressed air port (8) and results in dispensing of the granular material through the granule dispensing tube (20) under the force of exhaust air flowing through exhaust air conveyor tube (19) and allowing completion of the dispensing of granular material;
(c) activating the air solenoid valve (2) by depressing activation switch (46) which brings back the granule conveyor (6) to its normal position, and
(d) repeating cycle (b) to (c).

5. (canceled)

6. A method of operating an automatic dispensing modular assembly for granules with plurality of granule dispensing modules, in combination with a beverage dispensing assembly, comprising steps of:
(a) loading of the different granular materials in the canister cavities (12) of different granule dispensing modules and closing the canister cavities by respective canister lids like lid (13) with respective fixing means like fixing means (14,14);
(b) selecting the granular material to be dispensed out of the choice of granular materials available in different granule dispensing modules, by operating the appropriate switch on the front control panel (not shown) of the beverage dispensing assembly thereby activating the air solenoid valve (1) of the specific granule dispensing module in which the selected granular material is available, which moves forward the piston rod (17) of said module thereby moving the granule conveyor (6) of said module to a position where the granule volumetric dozer (16) is in vertical alignment with the granule dispensing port (7) and compressed air port (8) and results in dispensing of the granular material through the granule dispensing tube (20) under the force of the exhaust air flowing through exhaust air conveyor tube (19) thereby completing the dispensing of the granular material;
(c) depressing an appropriate switch on the front control panel (not shown) of the beverage dispensing assembly which activates the air solenoid valve (2) of the selected granule dispensing module thereby bringing back the granule conveyor (6) of said module back to its normal position; and
(d) repeating the above steps (b) to (c) with selecting of desired granular material by operating the appropriate switch on the front control panel (not shown) of the beverage dispensing assembly.

7. (canceled)

8. An assembly as claimed in claim 1 wherein said drive means is a pneumatic cylinder sub-assembly (40) comprising:
a pneumatic cylinder (4) provided with a piston rod (17) coupled to said granule conveyor coupler in horizontal alignment with said granule conveyor;
an air solenoid valve (1) provided at the rear end of said pneumatic cylinder (4), having an inlet port (10), an exhaust port (11) and a normally closed port (9) wherein said inlet port being connected to a compressed air storage tank (not shown) by an inlet tube (3) and an air compressor connecting tube (22) through a three-way connector (21) and said exhaust port being connected to the compressed air port (8) of said canister sub-assembly via exhaust air conveyor tube (19) and said normally closed port being connected to the pneumatic cylinder rear end port (25) of said pneumatic cylinder; and
an air solenoid valve (2) provided at the front end of said pneumatic cylinder having an inlet port (23), exhaust port (29) and normally closed port (24) wherein said inlet port is connected to the compressed air storage tank (not shown) by an inlet tube (27) and said air compressor connecting tube through said three-way connector and wherein said normally closed port is connected to the pneumatic cylinder front end port (26) of said pneumatic cylinder.

9. An assembly as claimed in claim 1 wherein alternate drive means for imparting forward and backward motion to said granule conveyor is selected from an electrically operated rod and a rack and pinion.

10. An assembly as claimed in claims 8 wherein alternate drive means for imparting forward and backward motion to said granule conveyor is selected from an electrically operated rod and a rack and pinion.
